(19) United States
(12) Patent Application Publication
(10) Pub. No.: US 2026/0213061 A1
(43) Pub. Date: Jul. 23, 2026

(54) COIL COMPONENT

(71) Applicant: TDK Corporation, Tokyo (JP)

(72) Inventors: Kouichi KAKUDA, Tokyo (JP); Hidenobu UMEDA, Tokyo (JP); Yuya OSHIMA, Tokyo (JP); Takuya NIIBORI, Tokyo (JP); Yuma ISHIKAWA, Tokyo (JP); Kenji KOMORITA, Tokyo (JP); Kaori SASAKI, Tokyo (JP)

(73) Assignee: TDK Corporation, Tokyo (JP)

(21) Appl. No.: 19/448,664

(22) Filed: Jan. 14, 2026

(30) Foreign Application Priority Data
Jan. 17, 2025 (JP) 2025-006867

(51) Int. Cl. H01F 27/28; H01F 1/34; H01F 27/24

(52) U.S. Cl. CPC H01F 27/2804; H01F 1/344; H01F 27/24; H01F 2027/2809

(57) ABSTRACT

A coil component according to an aspect of the present disclosure includes a body including a pair of end faces opposing each other, and a coil disposed within the body, wherein the coil includes at least one coil conductor, the body includes a first region and a second region provided at mutually different positions in a direction along a coil axis, the first region includes a ferrite composition composed of a main component and a sub-component.

### TECHNICAL FIELD

The present disclosure relates to a coil component.

### BACKGROUND

A known coil component includes a body and a coil disposed within the body (see, for example, Japanese Unexamined Patent Publication No. H8-55726). The body includes a pair of end faces opposing each other. The coil is disposed such that a coil axis thereof is aligned with a direction in which the pair of end faces oppose each other.

### SUMMARY

### Technical Problem

The present inventors have studied a coil component in which a body includes a first region and a second region composed of mutually different materials. As a result, it has become clear that in such a coil component, the sinterability of the second region is low, the inductance of the coil component decreases, and the reliability is low.

An aspect of the present disclosure provides a coil component with high reliability in which a decrease in inductance is suppressed even when a body includes a first region and a second region composed of mutually different materials.

### Solution to Problem

A coil component according to an aspect of the present disclosure includes a body including a pair of end faces opposing each other, and a coil disposed within the body, wherein the coil includes at least one coil conductor, the body includes a first region and a second region provided at mutually different positions in a direction along a coil axis, the first region includes a ferrite composition composed of a main component and a sub-component, the main component is composed of 35 to 50 mol % of iron oxide in terms of Fe₂O₃, 1 to 15 mol % of copper oxide in terms of CuO, 1 to 35 mol % of zinc oxide in terms of ZnO, and a remainder of nickel oxide, the sub-component includes 1.2 parts by mass or less of at least one lithium compound in terms of Li₂O with respect to 100 parts by mass of the main component, and the second region includes a non-magnetic material.

In the one aspect, a content of the at least one lithium compound in the sub-component may be 0.005 to 0.50 parts by mass in terms of Li₂O with respect to 100 parts by mass of the main component.

In the one aspect, the non-magnetic material may include a glass-based material.

In the one aspect, the non-magnetic material may have a magnetic permeability and a relative permittivity that are respectively smaller than a magnetic permeability and a relative permittivity of the ferrite composition.

In the coil component, the coil is disposed such that a coil axis thereof is aligned with a direction in which the pair of end faces oppose each other, the body includes a pair of first body portions each including a corresponding one of the pair of end faces, and a second body portion located between the pair of first body portions, the second body portion includes the first region and the second region, and the at least one coil conductor may include a coil conductor disposed in the second body portion.

In the coil component, a central portion among three portions obtained by trisecting the second body portion in a direction along the coil axis may include the second region.

In the one aspect, each of the three portions may include the first region and the second region.

In the one aspect, the second region may include a plurality of regions provided at respectively different positions in a direction along the coil axis.

In the one aspect, the plurality of regions may be provided symmetrically with respect to a central position of a length of the second body portion in a direction along the coil axis.

In the one aspect, the plurality of regions may be provided at substantially equal intervals in a direction along the coil axis.

In the one aspect, the plurality of regions may be provided so as to be biased toward one of the pair of first body portions.

### Advantageous Effects of Inventions

According to an aspect of the present disclosure, a coil component with high reliability is provided in which a decrease in inductance is suppressed even when a body includes a first region and a second region composed of mutually different materials.

### BRIEF DESCRIPTION OF THE DRAWINGS

FIG. 1 is a perspective view illustrating a coil component according to a first embodiment.

FIG. 2 is an exploded perspective view illustrating a coil and connection portions of the coil component according to the first embodiment.

FIG. 3 is a diagram illustrating a cross-sectional configuration of the coil component according to the first embodiment.

FIG. 4 is a diagram illustrating a cross-sectional configuration of a coil component according to a first modification of the first embodiment.

FIG. 5 is a diagram illustrating a cross-sectional configuration of a coil component according to a second modification of the first embodiment.

FIG. 6 is a diagram illustrating a cross-sectional configuration of a coil component according to a third modification of the first embodiment.

FIG. 7 is a diagram illustrating a cross-sectional configuration of a coil component according to a fourth modification of the first embodiment.

FIG. 8 is a diagram illustrating a cross-sectional configuration of a coil component according to a fifth modification of the first embodiment.

FIG. 9 is a diagram illustrating a cross-sectional configuration of a coil component according to a sixth modification of the first embodiment.

FIG. 10 is a diagram illustrating a cross-sectional configuration of a coil component according to a seventh modification of the first embodiment.

FIG. 11 is a diagram illustrating a cross-sectional configuration of a coil component according to an eighth modification of the first embodiment.

FIG. 12 is a diagram illustrating a cross-sectional configuration of a coil component according to a ninth modification of the first embodiment.

FIG. 13 is a perspective view illustrating a coil component according to a second embodiment.

FIG. 14 is an exploded perspective view illustrating a coil and connection portions of the coil component according to the second embodiment.

FIG. 15 is a diagram illustrating a cross-sectional configuration of the coil component according to the second embodiment.

### DETAILED DESCRIPTION

Hereinafter, embodiments of the present disclosure will be described in detail with reference to the accompanying drawings. In the description, the same reference numerals are used for the same elements or elements having the same functions, and redundant descriptions are omitted.

### [Coil Component]

### First Embodiment

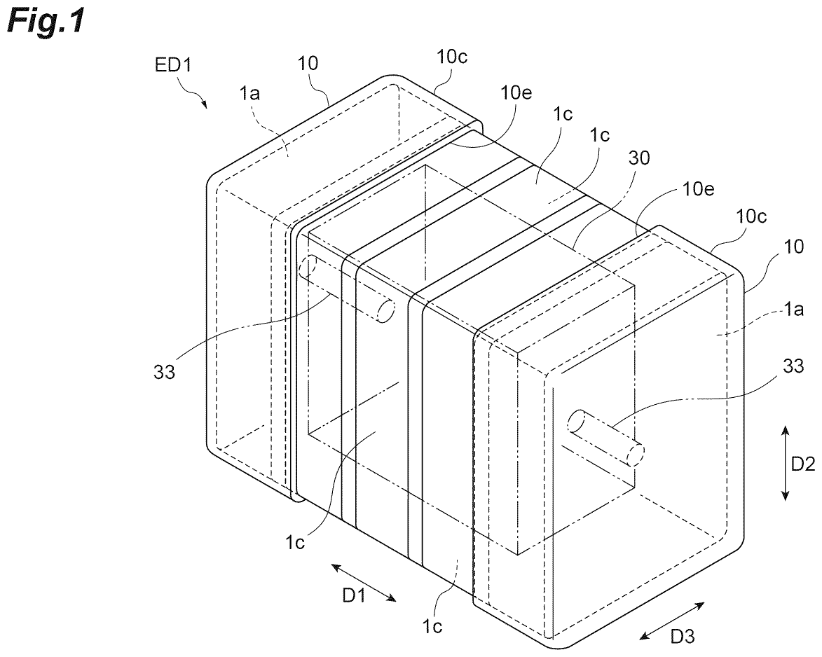

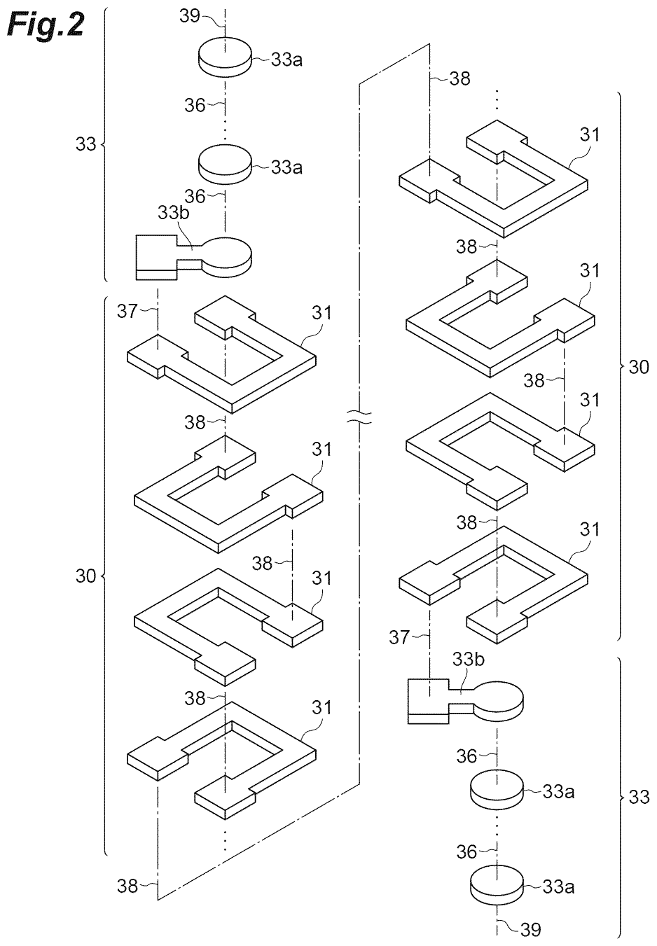

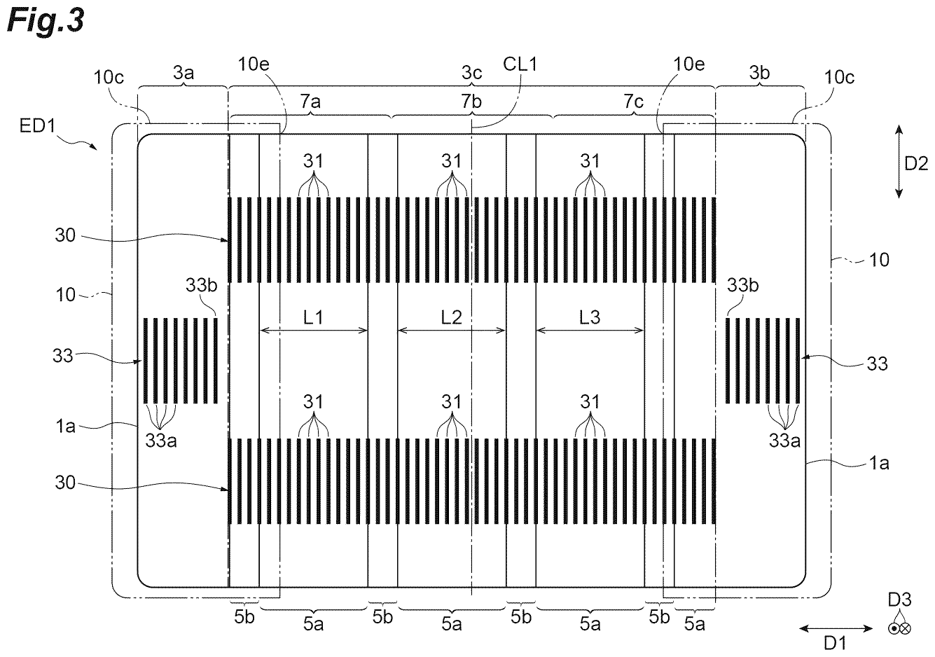

A configuration of a coil component ED1 according to a first embodiment will be described with reference to FIGS. 1 to 3. FIG. 1 is a perspective view illustrating the coil component according to the present embodiment. FIG. 2 is an exploded perspective view illustrating a coil and connection portions. FIG. 3 is a diagram illustrating a cross-sectional configuration of the coil component according to the present embodiment. In FIG. 3, hatching indicating a cross section is omitted. As illustrated in FIGS. 1 to 3, the coil component ED1 includes a body 1, a pair of external electrodes 10, and a coil 30. The pair of external electrodes 10 are disposed on a surface of the body 1. The coil 30 is disposed within the body 1 and is electrically connected to the pair of external electrodes 10. The coil 30 is disposed such that a coil axis thereof is aligned with a first direction D1.

The body 1 has, for example, a rectangular parallelepiped shape. In the present specification, the rectangular parallelepiped shape includes a shape of a rectangular parallelepiped in which corners and ridge portions are chamfered, or a shape of a rectangular parallelepiped in which corners and ridge portions are rounded. The body 1 includes a pair of end faces 1a opposing each other, and four side faces 1c connecting the pair of end faces 1a. A surface of the body 1 includes the pair of end faces 1a and the four side faces 1c. Each of the pair of end faces 1a and the four side faces 1c has a rectangular shape. In the present specification, the rectangular shape includes, for example, a shape in which each corner is chamfered, or a shape in which each corner is rounded.

The pair of end faces 1a oppose each other in the first direction D1. Each of the pair of end faces 1a has a smaller area than any of the four side faces 1c. Among the four side faces 1c, a pair of side faces 1c oppose each other in a second direction D2. Another pair of side faces 1c oppose each other in a third direction D3. The four side faces 1c extend in the first direction D1 so as to connect the pair of end faces 1a. The first direction D1 intersects with the second direction D2 and also intersects with the third direction D3. The second direction D2, for example, intersects with the third direction D3. In the present embodiment, the first direction D1, the second direction D2, and the third direction D3 are orthogonal to each other.

A length of the body 1 in the first direction D1 is, for example, 0.3 to 1.6 mm. A length of the body 1 in the second direction D2 is, for example, 0.1 to 1.0 mm. A length of the body 1 in the third direction D3 is, for example, 0.15 to 0.80 mm. In the body 1, for example, the first direction D1 is a long-side direction.

The pair of external electrodes 10 are disposed at both ends of the body 1. One external electrode 10 is, for example, disposed on one end face 1a. The other external electrode 10 is, for example, disposed on the other end face 1a. The pair of external electrodes 10 are separated from each other in the first direction D1. Each of the pair of external electrodes 10 includes an electrode portion 10c located on the four side faces 1c.

Each of the electrode portions 10c is located on the four side faces 1c. The electrode portion 10c includes an edge 10e. One electrode portion 10c extends on the four side faces 1c, for example, from one end face 1a to the edge 10e in a direction toward the other end face 1a. The other electrode portion 10c extends on the four side faces 1c, for example, from the other end face 1a to the edge 10e in a direction toward the one end face 1a. The edges 10e are located on the four side faces 1c.

The external electrode 10 includes a conductive material. The conductive material includes, for example, Ag, Pd, Cu, or Al. The conductive material includes, for example, an Ag—Pd alloy, an Ag—Cu alloy, an Ag—Au alloy, or an Ag—Pt alloy. The external electrode 10 includes, for example, a Ni plating film, a Sn plating film, a Cu plating film, or an Au plating film. The external electrode 10 may have a multilayer structure of these plating films, and may include a Ni plating film and a Sn plating film formed on the Ni plating film. A thickness of a portion of the external electrode 10 located on the end face 1a is, for example, 5 to 50 μm.

The coil 30 includes a plurality of coil conductors 31. The coil 30 may include at least one coil conductor 31. Each coil conductor 31 is disposed such that at least a part thereof overlaps with each other when viewed from the first direction D1. Each coil conductor 31 has, for example, a shape in which a part of a loop is discontinuous. Each coil conductor 31 includes a pair of ends. Each coil conductor 31 extends between the pair of ends along an annular trajectory. Among the plurality of coil conductors 31, mutually adjacent coil conductors 31 are connected to each other at the ends of each coil conductor 31 via a through hole conductor 38. When viewed from the first direction D1, the aforementioned mutually adjacent coil conductors 31 overlap at their corresponding ends. The coil component ED1 includes a pair of connection portions 33 disposed at both ends of the coil 30. The pair of connection portions 33 electrically connect the coil 30 and the pair of external electrodes 10. In FIG. 1, a two-dot chain line schematically indicates an outline of an outer shape of the coil 30 and the connection portions 33.

As illustrated in FIG. 2, each of the pair of connection portions 33 includes, for example, a plurality of conductors 33a and one conductor 33b. Among the plurality of conductors 33a, mutually adjacent conductors 33a are connected to each other via a through hole conductor 36. The through hole conductor 36 electrically connects the mutually adjacent conductors 33a to each other. The conductor 33a is, for example, not exposed on the end face 1a. When the conductor 33a is not exposed on the end face 1a, for example, the conductor 33a farthest from the coil 30 among the plurality of conductors 33a is connected to the external electrode 10 via a through hole conductor 39. The through hole conductor 39 is located, for example, between the conductor 33a farthest from the coil 30 and the external electrode 10, and electrically connects the conductor 33a farthest from the coil 30 and the external electrode 10 to each other. In the present embodiment, the conductor 33a farthest from the coil 30 may be exposed on the end face 1a. When the conductor 33a is exposed on the end face 1a, the conductor 33a exposed on the end face 1a is directly connected to the external electrode 10, and each of the pair of connection portions 33 does not include the through hole conductor 39. The coil component ED1 may include a configuration in which one of the pair of connection portions 33 includes the through hole conductor 39, and the other of the pair of connection portions 33 does not include the through hole conductor 39. In this configuration, one connection portion 33 is connected to the external electrode 10 at the through hole conductor 39, and the other connection portion 33 is connected to the external electrode 10 at the conductor 33a exposed on the end face 1a.

The conductor 33b is located between the coil 30 and the conductor 33a closest to the coil 30 among the plurality of conductors 33a. The conductor 33b electrically connects the plurality of conductors 33a and the coil 30. The conductor 33b includes, for example, one end connected to the conductor 33a and the other end connected to the coil 30. One end of the conductor 33b is connected to the conductor 33a via the through hole conductor 36. The other end of the conductor 33b is connected to the coil 30 via a through hole conductor 37. Among the plurality of coil conductors 31 included in the coil 30, the coil conductor 31 closest to the end face 1a is connected to the conductor 33b via the through hole conductor 37. In FIG. 2, illustration of some of the plurality of conductors 33a and the through hole conductors 36 is omitted.

The coil 30 and the connection portions 33 include a conductive material. The conductive material includes, for example, Ag, Pd, Au, Cu, or Al. The conductive material includes, for example, an Ag—Pd alloy, an Ag—Cu alloy, an Ag—Au alloy, or an Ag—Pt alloy. The coil 30 and the connection portions 33 include, for example, the same conductive material as the external electrodes 10. The coil 30 and the connection portions 33 may include a conductive material different from that of the external electrodes 10.

The body 1 includes a pair of body portions 3a, 3b and a body portion 3c. The pair of body portions 3a, 3b each include a corresponding one of the pair of end faces 1a. In the present embodiment, the body portion 3a includes one end face 1a, and the body portion 3b includes the other end face 1a. The body portion 3c is located between the body portion 3a and the body portion 3b in the first direction D1. In the present embodiment, one connection portion 33 is disposed in the body portion 3a. The other connection portion 33 is disposed in the body portion 3b. The coil 30 is disposed in the body portion 3c. In FIG. 3, illustration of the through hole conductor 36 is omitted.

For example, when the body portion 3a constitutes a first body portion, the body portion 3c constitutes a second body portion. For example, when the body portion 3b constitutes a first body portion, the body portion 3c constitutes a second body portion.

The body 1 includes, for example, a plurality of insulating layers having electrical insulation properties. In the present embodiment, the body 1 includes a plurality of insulating layers laminated in the first direction D1. The plurality of insulating layers are actually integrated to such an extent that their mutual boundaries are not visible. Each of the plurality of insulating layers has, for example, a rectangular shape when viewed from the first direction D1. In the present embodiment, the plurality of coil conductors 31 and the conductors 33a, 33b are respectively disposed between adjacent insulating layers among the plurality of insulating layers.

A boundary between each of the body portions 3a, 3b and the body portion 3c may be defined as follows.

For example, a plane that is parallel to one end face 1a included in the body portion 3a of the pair of end faces 1a and is in contact with a face opposing the one end face 1a, which is included in the coil conductor 31 closest to the one end face 1a, defines the boundary between the body portion 3a and the body portion 3c. For example, a plane that is parallel to the other end face 1a included in the body portion 3b of the pair of end faces 1a and is in contact with a face opposing the other end face 1a, which is included in the coil conductor 31 closest to the other end face 1a, defines the boundary between the body portion 3b and the body portion 3c.

The body portion 3c includes a plurality of first regions 5a and a plurality of second regions 5b. In the present embodiment, the body portion 3c includes, for example, four first regions 5a and four second regions 5b. The four first regions 5a and the four second regions 5b are provided at mutually different positions in the first direction D1. The first regions 5a and the second regions 5b are, for example, arranged alternately in the first direction D1. Each of the first region 5a and the second region 5b may be an insulating layer. The first region 5a and the second region 5b may be in direct contact. An intermediate layer may be formed at an interface between the first region 5a and the second region 5b.

The four second regions 5b are arranged at intervals L1, L2, and L3 from each other in a direction from the body portion 3a toward the body portion 3b in the first direction D1. That is, the two second regions 5b closer to the body portion 3a with respect to the central position CL1 are separated from each other by the interval L1. The two central second regions 5b are separated from each other by the interval L2. The two second regions 5b closer to the body portion 3b with respect to the central position CL1 are separated from each other by the interval L3. In the present embodiment, the intervals L1, L2, and L3 are substantially identical to each other. The four second regions 5b are provided at substantially equal intervals in the first direction D1.

In the present specification, “substantially equal intervals” may refer to intervals that are equal to each other, and may also refer to intervals with minute differences or manufacturing errors within a preset range. For example, when each of the plurality of intervals L1, L2, and L3 falls within a range of ±20% of an average value of the plurality of intervals L1, L2, and L3, the plurality of second regions 5b are considered to be provided at substantially equal intervals.

One edge 10e of the electrode portion 10c and the second region 5b are, for example, in contact with each other. In the present embodiment, one edge 10e and the second region 5b closest to the body portion 3a are in contact with each other. The second region 5b closest to the body portion 3a is covered by one electrode portion 10c. The other edge 10e and the second region 5b closest to the body portion 3b are in contact with each other. The second region 5b closest to the body portion 3b is covered by the other electrode portion 10c. The two central second regions 5b are, for example, not in contact with the edge 10e. The two central second regions 5b are, for example, exposed from the electrode portion 10c.

The first region 5a includes a ferrite composition composed of a main component and a sub-component. The main component is composed of 35.0 to 50.0 mol % of iron oxide in terms of Fe₂O₃, 1.0 to 15.0 mol % of copper oxide in terms of CuO, 1.0 to 35.0 mol % of zinc oxide in terms of ZnO, and a remainder of nickel oxide. The sub-component includes 1.2 parts by mass or less of at least one lithium compound in terms of Li₂O with respect to 100 parts by mass of the main component.

A content of the main component may be 50% by mass or more, 60% by mass or more, 70% by mass or more, 80% by mass or more, or 90% by mass or more, based on a total amount of the ferrite composition. A content of iron oxide in terms of Fe₂O₃ is 35.0 mol % or more, preferably 40.0 mol % or more, more preferably 42.0 mol % or more, and still more preferably 45.0 mol % or more, based on a total amount of the main component. The content of iron oxide in terms of Fe₂O₃ is 50.0 mol % or less, preferably 49.5 mol % or less, and more preferably 49.0 mol % or less, based on the total amount of the main component. When the content of iron oxide is 35.0 mol % or more, the magnetic permeability tends to be high, and a decrease in specific resistance tends to be suppressed. When the content of iron oxide is 50.0 mol % or less, the mechanical strength tends to be high, and the temperature characteristics of the magnetic permeability tend to be favorable.

A content of copper oxide in terms of CuO is 1.0 mol % or more, preferably 6.0 mol % or more, and more preferably 8.0 mol % or more, based on a total amount of the main component. The content of copper oxide in terms of CuO is 15.0 mol % or less, preferably 14.0 mol % or less, and more preferably 12.5 mol % or less, based on the total amount of the main component. When the content of copper oxide is 1.0 mol % or more, flexural strength tends to be high, and specific resistance tends to be high. When the content of copper oxide is 15.0 mol % or less, specific resistance tends to be high.

A content of zinc oxide in terms of ZnO is 1.0 mol % or more, preferably 6.0 mol % or more, more preferably 8.0 mol % or more, and still more preferably 10.0 mol % or more, based on a total amount of the main component. The content of zinc oxide in terms of ZnO is 35.0 mol % or less, preferably 30.0 mol % or less, and more preferably 27.0 mol % or less, based on the total amount of the main component. When the content of zinc oxide is 1.0 mol % or more, the magnetic permeability tends to be high. When the content of zinc oxide is 35.0 mol % or less, a decrease in the Curie temperature can be suppressed.

The remainder of the main component is nickel oxide. A content of nickel oxide in terms of NiO is, for example, 10.0 to 40.0 mol %, based on a total amount of the main component. When the content of nickel oxide is 15.0 mol % or more, a decrease in the Curie temperature can be suppressed. In addition, when the content of nickel oxide is 40.0 mol % or less, a real part u′ of a complex magnetic permeability at a high frequency around 900 MHz tends to be high.

The lithium compound is a compound including lithium atoms. The lithium compound is not particularly limited, but an inorganic compound is preferable from the viewpoint of ease of handling. Examples of such an inorganic compound include lithium carbonate (Li₂CO₃), lithium oxide (Li₂O), lithium hydroxide (LiOH), lithium acetate (CH₃CO₂Li), and hydrates thereof. Among these, lithium carbonate is preferable from the viewpoint of ease of handling. The lithium compound may be a glass including Li₂O. The glass is preferably a glass including Si, Li, and an alkaline earth metal (at least one selected from the group consisting of Ba, Sr, and Ca). The lithium compound may be used singly or in a combination of two or more.

A content of the at least one lithium compound in terms of Li₂O is more than 0 parts by mass, preferably 0.005 parts by mass or more, more preferably 0.01 parts by mass or more, and still more preferably 0.015 parts by mass or more, with respect to 100 parts by mass of the main component. The content of the at least one lithium compound in terms of Li₂O is 1.2 parts by mass or less, preferably 0.5 parts by mass or less, more preferably 0.2 parts by mass or less, and still more preferably 0.1 parts by mass or less, with respect to 100 parts by mass of the main component. When the content of the at least one lithium compound is 0.005 parts by mass or more and 0.50 parts by mass or less, the sinterability of the second region 5b is further enhanced. As a result, the coil component ED1 has even higher reliability.

The ferrite composition may further include, in addition to the above components, sub-components such as CoO, SiO₂, SnO₂, Bi₂O₃, B₂O₃, BaO, CaO, SrO, and MgO, for example. A content of these sub-components is not particularly limited, but is, for example, about 0.05 to 5.0 parts by mass with respect to 100 parts by mass of the main component.

The ferrite composition may further include, in addition to the above components, sub-components such as MnO, Na₂O, K₂O, ZrO₂, TiO₂, and Al₂O₃, for example. A content of these sub-components is not particularly limited, but is, for example, about 0.05 to 1.0 parts by mass with respect to 100 parts by mass of the main component.

A content of the ferrite composition in the first region 5a may be 50% by mass or more, 60% by mass or more, 70% by mass or more, 80% by mass or more, 90% by mass or more, 95% by mass or more, or 100% by mass, based on a total amount of the first region 5a.

The first region 5a may include oxides of inevitable impurity elements.

Examples of the inevitable impurity elements include elements such as C, S, Cl, As, Se, Br, Te, and I; typical metal elements such as Ga, Ge, Sr, Cd, In, Sb, and Pb; and transition metal elements such as Sc, V, Cr, Y, Nb, Mo, Pd, Hf, and Ta. A content of oxides of the inevitable impurity elements may be, for example, 0.1 parts by mass or less with respect to 100 parts by mass of the main component.

A thickness of each of the plurality of first regions 5a may be more than 0 μm, 4 μm or more, or 8 μm or more. The thickness of each of the plurality of first regions 5a may be 750 μm or less, 725 μm or less, or 700 μm or less.

A total value T1 of the thicknesses of the plurality of first regions 5a may be more than 0 μm, 8 μm or more, or 16 μm or more. The total value T1 of the thicknesses of the plurality of first regions 5a may be 1500 μm or less, 1450 μm or less, or 1400 μm or less.

The second region 5b includes a non-magnetic material. Examples of the non-magnetic material include a glass-based material, a forsterite material, a willemite material, an alumina material, a cordierite material, a steatite material, a mullite material, or a material in which these materials are mixed. The non-magnetic material is preferably a glass-based material, a forsterite material, and a willemite material from the viewpoint of relative permittivity, sinterability, and integrability with a magnetic body, and is preferably a mixture of a glass-based material and at least one selected from the group consisting of a forsterite material and a willemite material.

A content of the non-magnetic material in the second region 5b may be 50% by mass or more, 90% by mass or more, or 99% by mass or more. The content of the non-magnetic material in the second region 5b may be adjusted so that the magnetic permeability and the relative permittivity of the second region 5b become desired values. For example, the magnetic permeability of the second region 5b may be adjusted to be 1 to 10. For example, the relative permittivity of the second region 5b may be adjusted to be 3 to 15.

When the non-magnetic material is a mixture of a glass-based material and at least one selected from the group consisting of a forsterite material and a willemite material, a mass ratio of the glass-based material to the at least one selected from the group consisting of a forsterite material and a willemite material (mass of glass-based material: mass of at least one selected from the group consisting of forsterite material and willemite material) is preferably 1.5:98.5 to 23.1:76.9, and more preferably 2.9:97.1 to 13.0:87.0, from the viewpoint of sinterability.

The second region 5b may include at least one lithium compound. A content of the at least one lithium compound in the second region 5b in terms of Li₂O may have a gradient that increases closer to an interface between the first region 5a and the second region 5b. The content of the at least one lithium compound in the second region 5b in terms of Li₂O may be uniform. The content of the at least one lithium compound in terms of Li₂O may be 0% by mass or more, 0.001% by mass or more, or 0.01% by mass or more, and may be 1.2% by mass or less, 0.5% by mass or less, 0.2% by mass or less, or 0.1% by mass or less, based on a total amount of the second region 5b.

When a content of the at least one lithium compound (unit: % by mass) in the first region 5a based on a total amount of the first region 5a is L1, and a content of the at least one lithium compound (unit: % by mass) in the second region 5b based on a total amount of the second region 5b is L2, a ratio of L2 to L1 (L2/L1) may be 0 or more, 0.01 or more, 0.02 or more, or 0.05 or more, and may be 10.0 or less, 4.0 or less, 2.0 or less, or 1.0 or less.

A magnetic permeability of the ferrite composition included in the first region 5a may be, for example, 2 to 1500. A magnetic permeability of the non-magnetic material included in the second region 5b may be, for example, 1. A relative permittivity of the ferrite composition included in the first region 5a is, for example, 8 to 20. A relative permittivity of the non-magnetic material included in the second region 5b is, for example, 3 to 15.

The non-magnetic material included in the second region 5b may have a magnetic permeability and a relative permittivity that are respectively smaller than a magnetic permeability and a relative permittivity of the ferrite composition included in the first region 5a. That is, the magnetic permeability of the non-magnetic material included in the second region 5b may be smaller than the magnetic permeability of the ferrite composition included in the first region 5a, and the relative permittivity of the non-magnetic material included in the second region 5b may be smaller than the relative permittivity of the ferrite composition included in the first region 5a. This makes it possible to more reliably cause a peak of impedance to appear in a high-frequency band.

A thickness of each of the plurality of second regions 5b may be 3 μm or more, 5 μm or more, or 8 μm or more. The thickness of each of the plurality of second regions 5b may be 750 μm or less, 500 μm or less, or 250 μm or less.

A total value T2 of the thicknesses of the plurality of second regions 5b may be 3 μm or more, 5 μm or more, or 8 μm or more. The total value T2 of the thicknesses of the plurality of second regions 5b may be 1500 μm or less, 1000 μm or less, or 500 μm or less.

A ratio (T2/T1) of a total value T2 (unit: μm) of thicknesses of the plurality of second regions 5b to a total value T1 (unit: μm) of thicknesses of the plurality of first regions 5a is preferably 0.002 or more, more preferably 0.01 or more, and still more preferably 0.05 or more, from the viewpoint that the sinterability of the second region 5b is further enhanced and the coil component is more reliable. The ratio (T2/T1) is preferably 2.0 or less, more preferably 1.0 or less, and still more preferably 0.5 or less, from the viewpoint that a proportion of the first region 5a increases and inductor performance is improved.

The body portion 3c includes three portions, namely, a portion 7a, a portion 7b, and a portion 7c. The portion 7a, the portion 7b, and the portion 7c are arranged, for example, in the order of the portion 7a, the portion 7b, and the portion 7c in the first direction D1. The portion 7b is located in the center among the portions 7a, 7b, and 7c. The portion 7a is located near the body portion 3a. The portion 7c is located near the body portion 3b. The portions 7a, 7b, and 7c, for example, trisect the body portion 3c in the first direction D1.

In the present specification, “trisecting” may refer to trisecting including minute differences or manufacturing errors within a preset range. For example, when a length of each of the portions 7a, 7b, and 7c in the first direction D1 falls within a range of +20% of an average value of the lengths of the portions 7a, 7b, and 7c in the first direction D1, each of the portions 7a, 7b, and 7c is considered to be a trisection of the body portion 3c in the first direction D1.

Each of the portions 7a, 7b, and 7c includes, for example, a first region 5a and a second region 5b. In the present embodiment, the portion 7a includes one first region 5a and two second regions 5b. The portion 7b includes two first regions 5a and two second regions 5b. The portion 7c includes two first regions 5a and one second region 5b. Mutually adjacent portions 7a and 7b include one first region 5a and one second region 5b located at a boundary between the portions 7a and 7b in a shared manner. Mutually adjacent portions 7b and 7c include one first region 5a and one second region 5b located at a boundary between the portions 7b and 7c in a shared manner. In each of the plurality of second regions 5b, three insulating layers including a second material are consecutively laminated with each other without sandwiching the first region 5a.

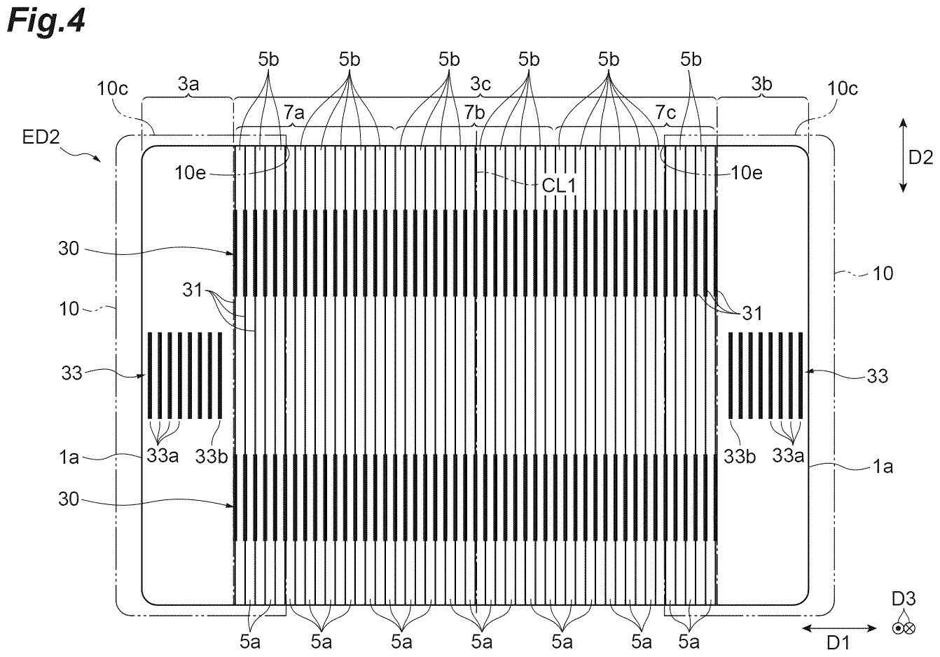

A coil component ED2 according to a first modification of the present embodiment will be described with reference to FIG. 4. FIG. 4 is a diagram illustrating a cross-sectional configuration of the coil component according to the first modification of the present embodiment. In FIG. 4, hatching indicating a cross section and illustration of the through hole conductor 36 are omitted. A configuration of the coil component ED2 is the same as the configuration of the coil component ED1 except for the arrangement of the first regions 5a and the second regions 5b.

The body portion 3c includes twenty-four first regions 5a and twenty-four second regions 5b. The twenty-four second regions 5b are provided at respectively different positions in the first direction D1. Each of the portions 7a, 7b, and 7c includes eight first regions 5a and eight second regions 5b.

In the first modification, the twenty-four second regions 5b are provided at substantially equal intervals in the first direction D1. For example, one insulating layer included in the second region 5b and one insulating layer included in the first region 5a are alternately laminated. One edge 10e and the three second regions 5b close to the body portion 3a are in contact with each other. The other edge 10e and the two second regions 5b close to the body portion 3b are in contact with each other. For example, the second regions 5b other than the five second regions 5b described above are not in contact with the edge 10e and are exposed from the electrode portion 10c.

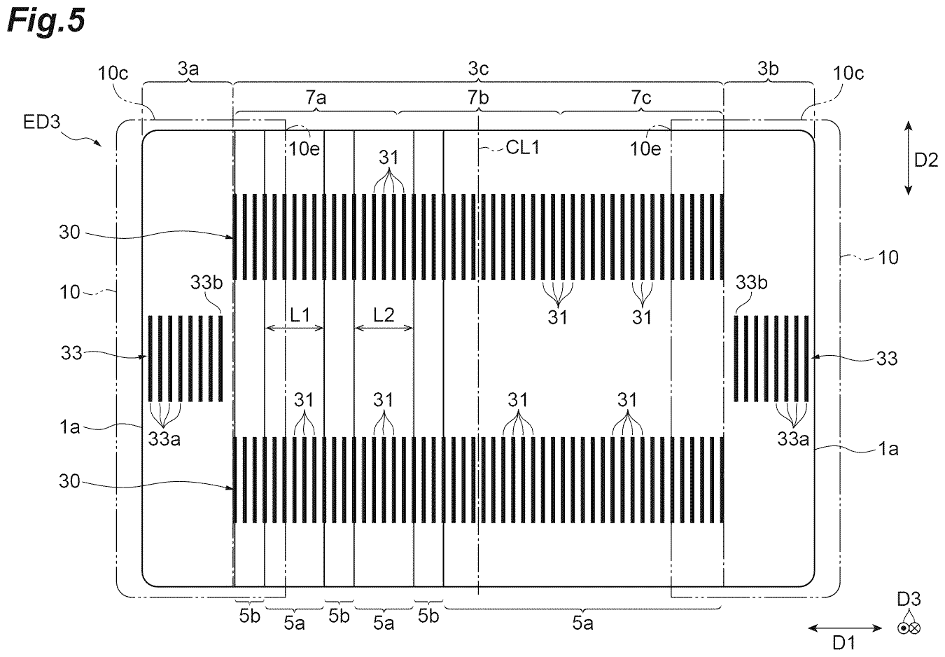

A coil component ED3 according to a second modification of the present embodiment will be described with reference to FIG. 5. FIG. 5 is a diagram illustrating a cross-sectional configuration of the coil component according to the second modification of the present embodiment. In FIG. 5, hatching indicating a cross section and illustration of the through hole conductor 36 are omitted. A configuration of the coil component ED3 is the same as the configuration of the coil component ED1 except for the arrangement of the first regions 5a and the second regions 5b.

The body portion 3c includes three first regions 5a and three second regions 5b. The three second regions 5b are provided at respectively different positions in the first direction D1. The portion 7a includes two first regions 5a and two second regions 5b. The portion 7b includes two first regions 5a and one second region 5b. The portion 7c includes one first region 5a and does not include a second region 5b.

In the second modification, each of the three second regions 5b is provided so as to be biased toward the body portion 3a. The three second regions 5b are provided near the body portion 3a with respect to the central position CL1. The three second regions 5b are arranged at intervals L1 and L2 from each other in a direction from the body portion 3a toward the body portion 3b in the first direction D1. For example, the intervals L1 and L2 are substantially identical to each other. The three second regions 5b are provided at substantially equal intervals in the first direction D1. In each of the three second regions 5b, three insulating layers including a second material are consecutively laminated with each other without sandwiching the first region 5a.

One edge 10e and the second region 5b closest to the body portion 3a are in contact with each other. The other edge 10e and the second region 5b are not in contact with each other. The two second regions 5b close to the body portion 3b are not in contact with the edge 10e and are exposed from the electrode portion 10c.

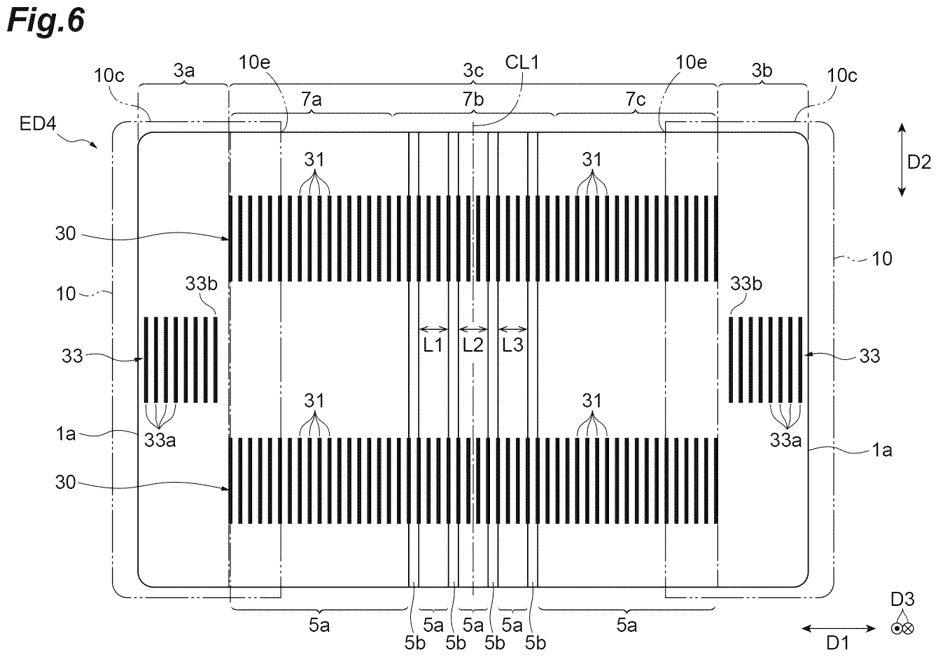

A coil component ED4 according to a third modification of the present embodiment will be described with reference to FIG. 6. FIG. 6 is a diagram illustrating a cross-sectional configuration of the coil component according to the third modification of the present embodiment. In FIG. 6, hatching indicating a cross section and illustration of the through hole conductor 36 are omitted. A configuration of the coil component ED4 is the same as the configuration of the coil component ED1 except for the arrangement of the first regions 5a and the second regions 5b.

The body portion 3c includes five first regions 5a and four second regions 5b. The four second regions 5b are provided at respectively different positions in the first direction D1. In the third modification, the four second regions 5b are provided symmetrically with respect to the central position CL1. Among the four second regions 5b, intervals from the two central second regions 5b to the central position CL1 are substantially identical to each other. Among the four second regions 5b, intervals from the two second regions 5b at both ends to the central position CL1 are substantially identical to each other. The central position CL1 is located between the two central second regions 5b among the four second regions 5b.

In the example illustrated in FIG. 6, the portions 7a and 7c include one first region 5a and do not include a second region 5b. The portion 7b includes five first regions 5a and four second regions 5b. In the third modification, each of the portions 7a and 7c may include a second region 5b. For example, each of the portions 7a and 7c may include two first regions 5a and one second region 5b, and the portion 7b may include three first regions 5a and two second regions 5b. For example, each of the portions 7a and 7c may include three first regions 5a and two second regions 5b, and the portion 7b may include one first region 5a and not include a second region 5b.

The four second regions 5b are arranged at intervals L1, L2, and L3 from each other in a direction from the body portion 3a toward the body portion 3b in the first direction D1. In the third modification, the intervals L1, L2, and L3 are substantially identical to each other. The four second regions 5b are provided at substantially equal intervals in the first direction D1.

In each of the four second regions 5b, one insulating layer including a second material is laminated. The edge 10e and the second region 5b are not in contact with each other. The four second regions 5b are not in contact with the edge 10e and are exposed from the electrode portion 10c.

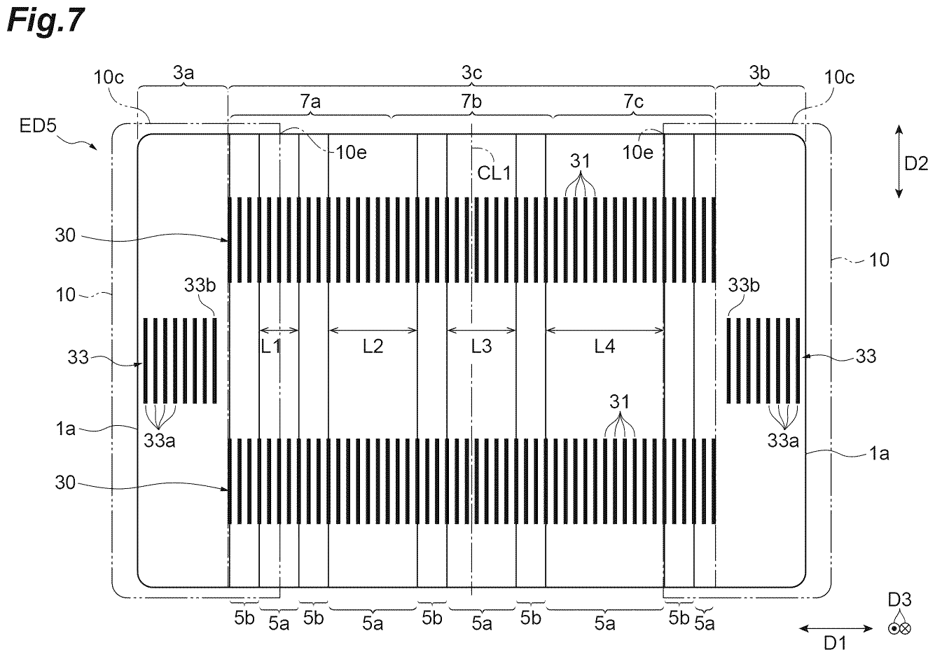

A coil component ED5 according to a fourth modification of the present embodiment will be described with reference to FIG. 7. FIG. 7 is a diagram illustrating a cross-sectional configuration of the coil component according to the fourth modification of the present embodiment. In FIG. 7, hatching indicating a cross section and illustration of the through hole conductor 36 are omitted. A configuration of the coil component ED5 is the same as the configuration of the coil component ED1 except for the arrangement of the first regions 5a and the second regions 5b.

The body portion 3c includes four first regions 5a and five second regions 5b. The five second regions 5b are provided at respectively different positions in the first direction D1. The portion 7a includes two first regions 5a and two second regions 5b. The portion 7b includes three first regions 5a and two second regions 5b. The portion 7c includes two first regions 5a and one second region 5b.

In the fourth modification, the five second regions 5b are not provided symmetrically with respect to the central position CL1. The five second regions 5b are arranged at intervals L1, L2, L3, and L4 from each other in a direction from the body portion 3a toward the body portion 3b in the first direction D1. In the fourth modification, the intervals L1, L2, L3, and L4 are different from each other. For example, the interval L4 is the largest, and the interval L2 is the next largest. Then, the interval L3 is the next largest, and the interval L1 is the smallest. In each of the five second regions 5b, three insulating layers including a second material are consecutively laminated with each other without sandwiching the first region 5a.

In the fourth modification, one edge 10e and the second region 5b closest to the body portion 3a are in contact with each other. The other edge 10e and the second region 5b closest to the body portion 3b are in contact with each other. For example, the three second regions 5b located from the third to fifth from the body portion 3a are not in contact with the edge 10e and are exposed from the electrode portion 10c.

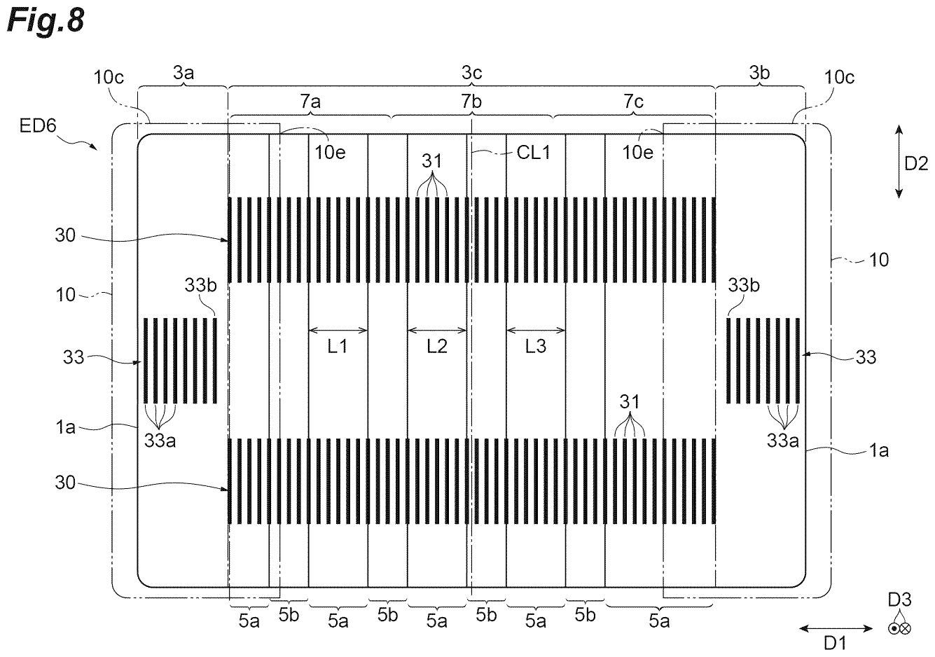

A coil component ED6 according to a fifth modification of the present embodiment will be described with reference to FIG. 8. FIG. 8 is a diagram illustrating a cross-sectional configuration of the coil component according to the fifth modification of the present embodiment. In FIG. 8, hatching indicating a cross section and illustration of the through hole conductor 36 are omitted. A configuration of the coil component ED6 is the same as the configuration of the coil component ED1 except for the arrangement of the first regions 5a and the second regions 5b.

The body portion 3c includes five first regions 5a and four second regions 5b. The four second regions 5b are provided at respectively different positions in the first direction D1. The portion 7a includes two first regions 5a and two second regions 5b. The portion 7b includes two first regions 5a and two second regions 5b. The portion 7c includes two first regions 5a and one second region 5b.

In the fifth modification, the four second regions 5b are not provided symmetrically with respect to the central position CL1. The four second regions 5b are provided so as to be biased toward the body portion 3a. In each of the four second regions 5b, four insulating layers including a second material are consecutively laminated with each other without sandwiching the first region 5a. The four second regions 5b are arranged at intervals L1, L2, and L3 from each other in a direction from the body portion 3a toward the body portion 3b in the first direction D1. For example, the intervals L1, L2, and L3 are substantially identical to each other. The four second regions 5b are provided at substantially equal intervals in the first direction D1.

One edge 10e and a part of the second region 5b closest to the body portion 3a are in contact with each other. The part of the second region 5b closest to the body portion 3a is covered by the electrode portion 10c. One edge 10e and the other part of the second region 5b closest to the body portion 3a are not in contact with each other. The other part of the second region 5b closest to the body portion 3a is not covered by the one electrode portion 10c. The other edge 10e and the second regions 5b are not in contact with each other. The three second regions 5b close to the body portion 3b are not in contact with the edge 10e and are exposed from the electrode portion 10c.

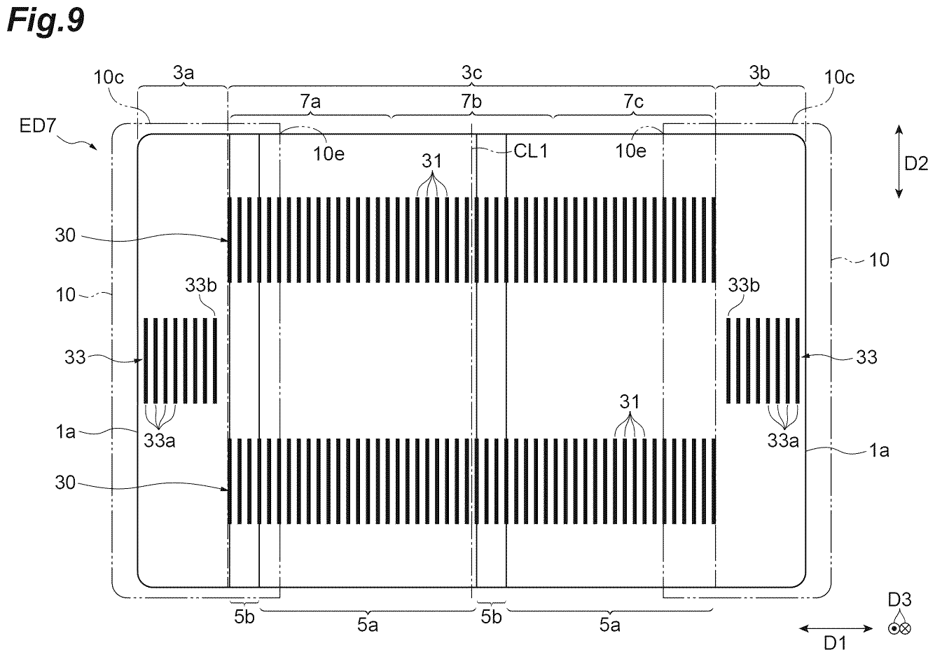

A coil component ED7 according to a sixth modification of the present embodiment will be described with reference to FIG. 9. FIG. 9 is a diagram illustrating a cross-sectional configuration of the coil component according to the sixth modification of the present embodiment. In FIG. 9, hatching indicating a cross section and illustration of the through hole conductor 36 are omitted. A configuration of the coil component ED7 is the same as the configuration of the coil component ED1 except for the arrangement of the first regions 5a and the second regions 5b.

The body portion 3c includes two first regions 5a and two second regions 5b. The two second regions 5b are provided at respectively different positions in the first direction D1. The portion 7a includes one first region 5a and one second region 5b. The portion 7b includes two first regions 5a and one second region 5b. The portion 7c includes one first region 5a and does not include a second region 5b.

In the sixth modification, the two second regions 5b are not provided symmetrically with respect to the central position CL1. The two second regions 5b are provided so as to be biased toward the body portion 3a. In each of the two second regions 5b, three insulating layers including a second material are consecutively laminated with each other without sandwiching the first region 5a.

One edge 10e and the second region 5b close to the body portion 3a are in contact with each other. The second region 5b close to the body portion 3a is covered by one electrode portion 10c. The second region 5b close to the body portion 3b is not in contact with the edge 10e and is exposed from the electrode portion 10c.

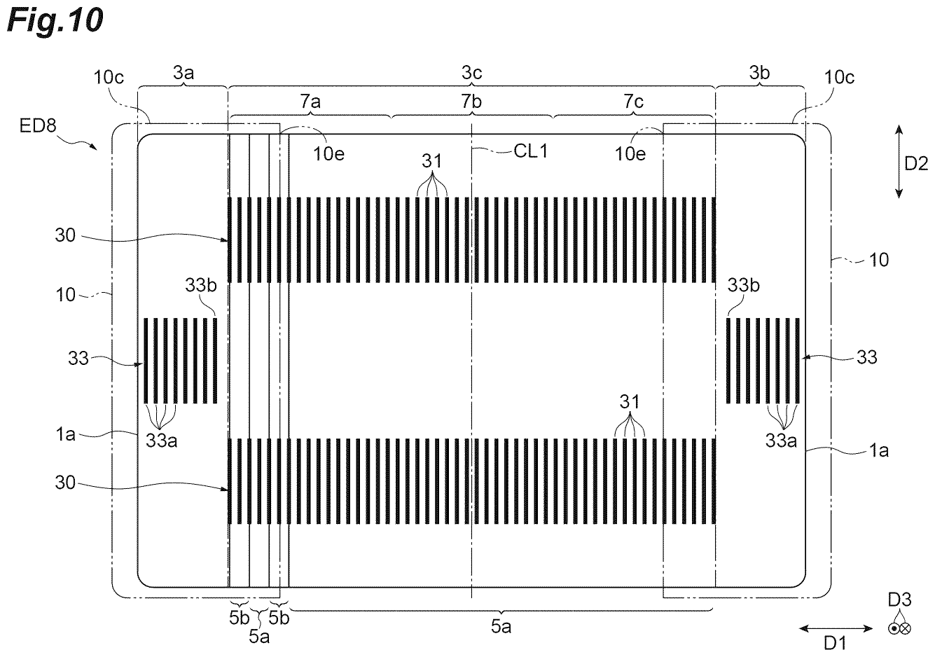

A coil component ED8 according to a seventh modification of the present embodiment will be described with reference to FIG. 10. FIG. 10 is a diagram illustrating a cross-sectional configuration of the coil component according to the seventh modification of the present embodiment. In FIG. 10, hatching indicating a cross section and illustration of the through hole conductor 36 are omitted. A configuration of the coil component ED8 is the same as the configuration of the coil component ED1 except for the arrangement of the first regions 5a and the second regions 5b.

The body portion 3c includes two first regions 5a and two second regions 5b. The two second regions 5b are provided at respectively different positions in the first direction D1. The portion 7a includes two first regions 5a and two second regions 5b. The portions 7b and 7c include one first region 5a and do not include a second region 5b.

In the seventh modification, the two second regions 5b are not provided symmetrically with respect to the central position CL1. The two second regions 5b are provided so as to be biased toward the body portion 3a. In each of the two second regions 5b, two insulating layers including a second material are consecutively laminated with each other without sandwiching the first region 5a.

One edge 10e and the second region 5b closest to the body portion 3a are in contact with each other. One edge 10e and a part of the second region 5b located second from the body portion 3a are in contact with each other. The second region 5b closest to the body portion 3a and the part of the second region 5b located second from the body portion 3a are covered by one electrode portion 10c. One edge 10e and the other part of the second region 5b located second from the body portion 3a are not in contact with each other. The other part of the second region 5b located second from the body portion 3a is exposed from one electrode portion 10c. The other edge 10e is not in contact with any of the second regions 5b. The other edge 10e does not cover any of the second regions 5b.

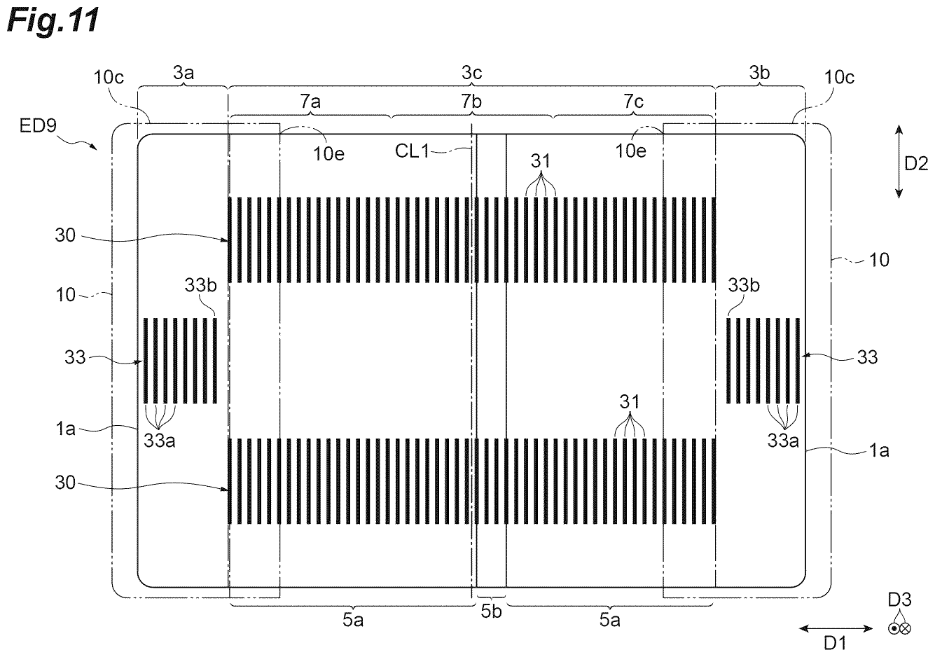

A coil component ED9 according to an eighth modification of the present embodiment will be described with reference to FIG. 11. FIG. 11 is a diagram illustrating a cross-sectional configuration of the coil component according to the eighth modification of the present embodiment. In FIG. 11, hatching indicating a cross section and illustration of the through hole conductor 36 are omitted. A configuration of the coil component ED9 is the same as the configuration of the coil component ED1 except for the arrangement of the first regions 5a and the second regions 5b.

The body portion 3c includes two first regions 5a and one second region 5b. The portions 7a and 7c include one first region 5a and do not include a second region 5b. The portion 7b includes two first regions 5a and one second region 5b. In the one second region 5b, three insulating layers including a second material are consecutively laminated with each other without sandwiching the first region 5a. The one second region 5b is not in contact with the edge 10e and is exposed from the electrode portion 10c.

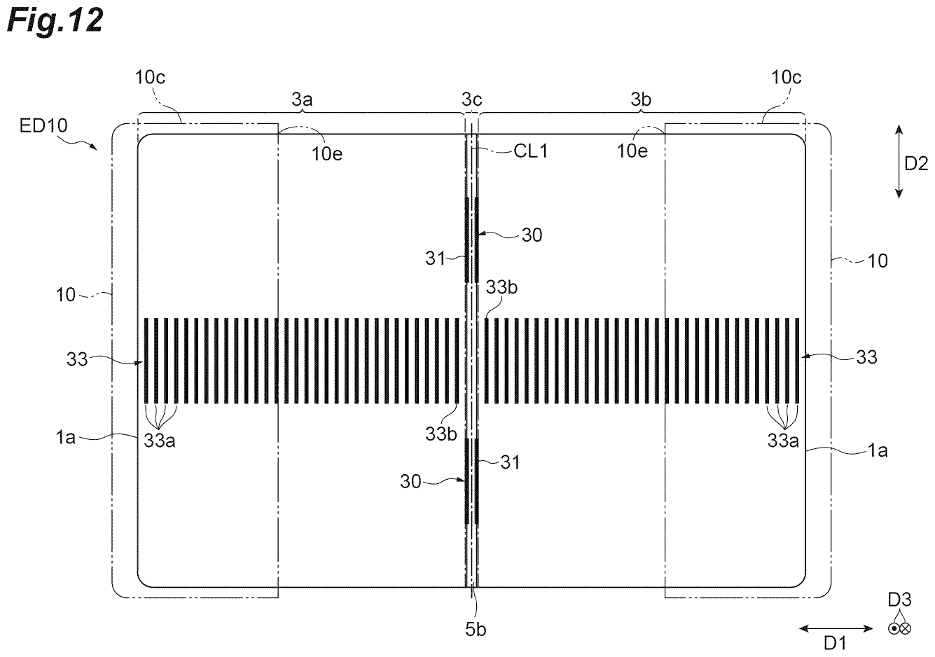

A coil component ED10 according to a ninth modification of the present embodiment will be described with reference to FIG. 12. FIG. 12 is a diagram illustrating a cross-sectional configuration of the coil component according to the ninth modification of the present embodiment. In FIG. 12, hatching indicating a cross section and illustration of the through hole conductor 36 are omitted. A configuration of the coil component ED10 is the same as the configuration of the coil component ED1 except for the sizes of the body portions 3a, 3b, and 3c, the configuration of the coil 30, and the arrangement of the first regions 5a and the second regions 5b.

Each of the body portions 3a and 3b is longer in the first direction D1 than the body portions 3a and 3b according to the present embodiment. The number of coil conductors 31 included in the coil 30 according to the ninth modification is smaller than the number of coil conductors 31 included in the coil 30 according to the present embodiment. The body portion 3c includes two first regions 5a and one second region 5b. In the ninth modification, the portions 7a and 7c include one first region 5a and do not include a second region 5b. The portion 7b includes at least the second region 5b. The one second region 5b is not in contact with the edge 10e and is exposed from the electrode portion 10c.

### Second Embodiment

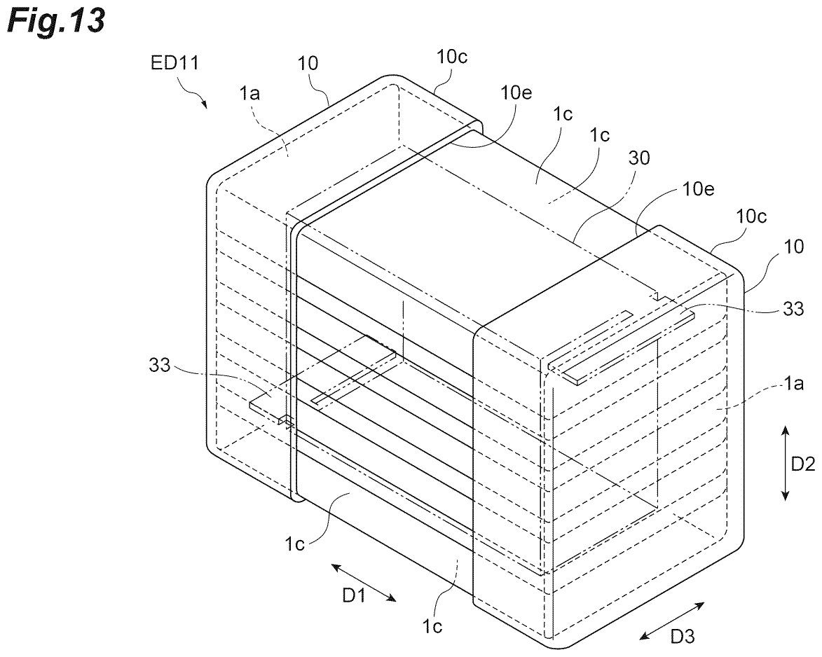

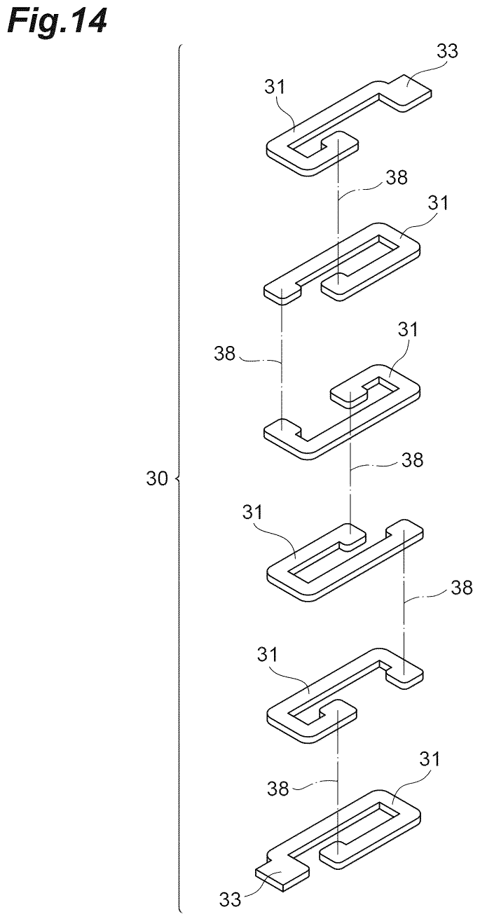

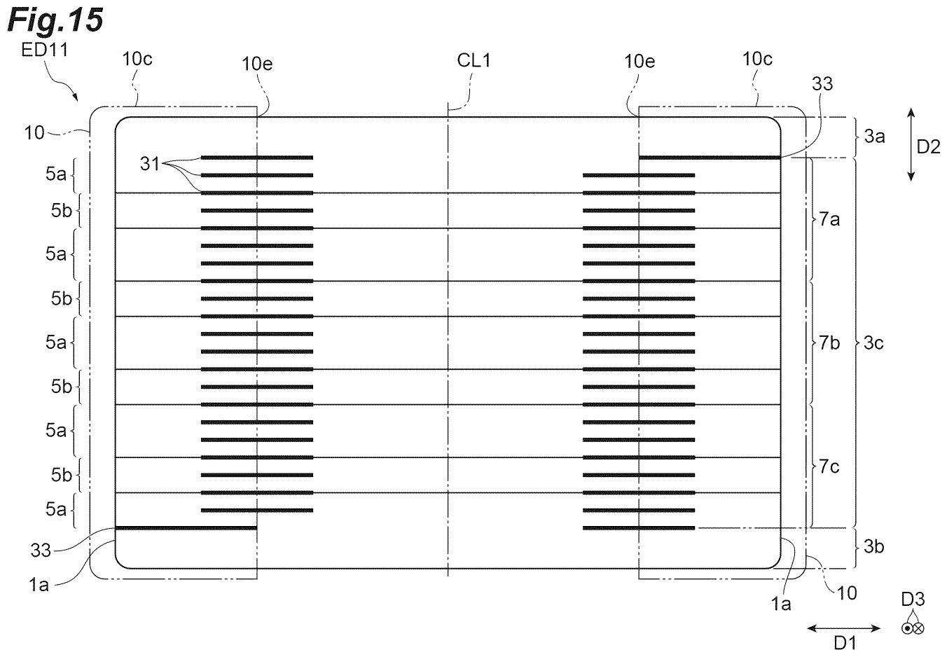

A configuration of a coil component ED11 according to the present embodiment will be described with reference to FIGS. 13 to 15. Aspects not described below are the same as for the coil component according to the first embodiment, unless inconsistencies arise. FIG. 13 is a perspective view illustrating the coil component according to the present embodiment. FIG. 14 is an exploded perspective view illustrating a coil and connection portions. FIG. 15 is a diagram illustrating a cross-sectional configuration of the coil component according to the present embodiment. In FIG. 15, hatching indicating a cross section is omitted.

In the coil component according to the above embodiment, the coil 30 is disposed such that the coil axis is aligned with the first direction D1. On the other hand, in the coil component ED11, the coil 30 is disposed such that the coil axis is aligned with the second direction D2. In the coil component according to the above embodiment, the body portion 3a includes one end face 1a, and the body portion 3b includes the other end face 1a. The body portion 3c is located between the body portion 3a and the body portion 3b in the first direction D1. On the other hand, in the coil component ED11, the body portion 3a includes one side face 1c, and the body portion 3b includes a side face 1c facing the one side face 1c. The body portion 3c is located between the body portion 3a and the body portion 3b in the second direction D2. In the coil component according to the above embodiment, the portion 7a, the portion 7b, and the portion 7c are arranged, for example, in the order of the portion 7a, the portion 7b, and the portion 7c in the first direction D1. In the coil component ED11, the portion 7a, the portion 7b, and the portion 7c are arranged, for example, in the order of the portion 7a, the portion 7b, and the portion 7c in the second direction D2.

As described above, in the coil components ED1 to ED11, at least one coil conductor 31 includes a coil conductor 31 disposed in the body portion 3c, and a magnetic flux generated by the coil conductor 31 reliably passes through the body portion 3c along a direction along the coil axis. That is, the body portion 3c affects the characteristics of the coil component, for example, impedance and inductance. The body portion 3c includes the first region 5a and the second region 5b.

Since the body portion 3c includes the first region 5a and the second region 5b provided at mutually different positions in the direction along the coil axis, the magnetic flux generated by the coil conductor 31 reliably passes through the first region 5a and the second region 5b. That is, while the inductance of the coil components ED1 to ED10 is improved by the first region 5a, other characteristics can be improved by the second region 5b. For example, the coil components ED1 to ED10 achieve high impedance in a high frequency band, for example, a frequency band of 700 MHz to 3 GHz.

Furthermore, in the coil components ED1 to ED11, since the first region 5a includes at least one lithium compound as a sub-component, element diffusion occurring at the interface between the first region 5a and the second region 5b can be suppressed, so that the sinterability of the second region 5b is enhanced. In addition, since the at least one lithium compound included in the first region 5a is 1.2 parts by mass or less, a decrease in the sinterability of the first region 5a can be suppressed. As a result, in the coil components ED1 to ED11, changes in characteristics due to thermal shock or the like are suppressed, and they have high reliability. In addition, since the at least one lithium compound included in the first region 5a is 1.2 parts by mass or less, a decrease in the magnetic permeability of the first region 5a is suppressed, and a decrease in inductance can be suppressed.

In the coil components ED1 to ED10, the coil 30 is disposed such that a coil axis thereof is aligned with a direction in which the pair of end faces 1a oppose each other; the body 1 includes the body portion 3a and the body portion 3b each including a corresponding one of the pair of end faces, and the body portion 3c located between the body portion 3a and the body portion 3b; the body portion 3c includes the first region 5a and the second region 5b, and the at least one coil conductor 31 includes a coil conductor 31 disposed in the body portion 3c. Therefore, the coil components ED1 to ED10 are excellent in high-frequency characteristics.

In the coil components ED1 to ED7, ED9, ED10, and ED11, a central portion 7b among three portions 7a, 7b, and 7c obtained by trisecting the body portion 3c in the first direction D1 or D2 includes the second region 5b.

In the coil components ED1 to ED7, ED9, ED10, and ED11, the second region 5b, which causes a peak of impedance to appear in a high-frequency band, is disposed in the portion 7b. Therefore, the coil components ED1 to ED7, ED9, ED10, and ED11 reliably cause a peak of impedance to appear in a high-frequency band.

In the coil components ED1, ED2, ED5, ED6, and ED11, each of the three portions 7a, 7b, and 7c includes the first region 5a and the second region 5b.

In the coil components ED1, ED2, ED5, ED6, and ED11, the second region 5b, which causes a peak of impedance to appear in a high-frequency band, is disposed in each of the three portions 7a, 7b, and 7c.

Therefore, the coil components ED1, ED2, ED5, ED6, and ED11 more reliably cause a peak of impedance to appear in a high-frequency band.

In the coil components ED1 to ED8, the second region 5b includes a plurality of second regions 5b provided at respectively different positions in the first direction D1.

In the coil components ED1 to ED8, the plurality of second regions 5b, which cause a peak of impedance to appear in a high-frequency band, are disposed in the body portion 3c. Therefore, the coil components ED1 to ED8 more reliably cause a peak of impedance to appear in a high-frequency band.

In the coil component ED11, the second region 5b includes a plurality of second regions 5b provided at respectively different positions in the second direction D2.

In the coil component ED11, the plurality of second regions 5b, which cause a peak of impedance to appear in a high-frequency band, are disposed in the body portion 3c. Therefore, the coil component ED11 more reliably causes a peak of impedance to appear in a high-frequency band.

In the coil component ED4, the plurality of second regions 5b are provided symmetrically with respect to the central position CL1 of the body portion 3c.

In the coil component ED4, the plurality of second regions 5b, which cause a peak of impedance to appear in a high-frequency band, are provided symmetrically with respect to the central position CL1. Therefore, the coil component ED4 more reliably causes a peak of impedance to appear in a high-frequency band.

In the coil components ED1 to ED4 and ED6, the plurality of second regions 5b are provided at substantially equal intervals in the first direction D1.

In the coil components ED1 to ED4 and ED6, the plurality of second regions 5b, which cause a peak of impedance to appear in a high-frequency band, are provided at substantially equal intervals. Therefore, the coil components ED1 to ED4 and ED6 more reliably cause a peak of impedance to appear in a high-frequency band.

In the coil component ED11, the plurality of second regions 5b are provided at substantially equal intervals in the second direction D2.

In the coil component ED11, the plurality of second regions 5b, which cause a peak of impedance to appear in a high-frequency band, are provided at substantially equal intervals. Therefore, the coil component ED11 more reliably causes a peak of impedance to appear in a high-frequency band.

In the coil components ED3, ED7, and ED8, the plurality of second regions 5b are provided so as to be biased toward one body portion 3a of the pair of body portions 3a and 3b.

In the coil components ED3, ED7, and ED8, even when elements included in the second region 5b diffuse into the body portion 3c, the elements are unlikely to diffuse into the body portion 3c close to the body portion 3b. The first region 5a provided in the body portion 3c close to the body portion 3b is unlikely to be affected by element diffusion. Therefore, the coil components ED3, ED7, and ED8 reliably suppress a decrease in inductance.

In the coil components ED4 and ED9, the portion 7b includes the first region 5a, and the portions 7a and 7c do not include the second region 5b. Even when elements included in the second region 5b diffuse into the body portion 3c, the elements are unlikely to diffuse into the body portion 3c close to the body portions 3a and 3b. The body portion 3c close to the body portions 3a and 3b is unlikely to be affected by element diffusion. Therefore, the coil components ED4 and ED9 reliably suppress a decrease in inductance.

In the coil components ED1 to ED11, the at least one coil conductor 31 includes a plurality of coil conductors 31. The plurality of coil conductors 31 include a coil conductor 31 disposed in the second region 5b.

In the coil components ED1 to ED11, the plurality of coil conductors 31 can be disposed in the second region 5b. Therefore, the appearance of a peak of impedance in a high-frequency band is achieved by the plurality of coil conductors 31. As a result, the coil components ED1 to ED11 more reliably cause a peak of impedance to appear in a high-frequency band.

The coil components ED1 to ED3 and ED5 to ED8 include a pair of external electrodes 10 disposed at both ends of the body 1 in the first direction D1 and electrically connected to the coil 30. The body 1 includes a side face 1c connecting the pair of end faces 1a. One external electrode 10 includes an electrode portion 10c located on the side face 1c. An edge 10e of the one electrode portion 10c and the second region 5b are in contact with each other. The other external electrode 10 includes another electrode portion 10c located on the side face 1c. An edge 10e of the other electrode portion 10c and the second region 5b are in contact with each other.

The coil components ED1 to ED3 and ED5 to ED8 reduce stray capacitance formed between the coil 30 and the external electrodes 10. Therefore, the coil components ED1 to ED3 and ED5 to ED8 more reliably cause a peak of impedance to appear in a high-frequency band.

### [Manufacturing Method of Coil Component]

Hereinafter, a manufacturing method of a coil component according to an embodiment of the present disclosure will be described.

### <Preparation Step of Composition for Forming First Region>

As main components, iron oxide, copper oxide, zinc oxide, and nickel oxide are weighed in predetermined proportions. A predetermined amount of at least one lithium compound is added to the iron oxide, copper oxide, zinc oxide, and nickel oxide. Each component may include inevitable impurities. Next, these weighed materials are wet-mixed to obtain a raw material mixture.

The obtained raw material mixture is dried and then calcined. The calcination temperature may be, for example, 500° C. or higher and 900° C. or lower. The raw material mixture after calcination is pulverized. Thereby, a powdery composition for forming a first region is obtained. When the raw material mixture after calcination forms large lumps, coarse pulverization may be performed, and then wet pulverization may be performed using a ball mill, an attritor, or the like. The wet pulverization may be performed until an average particle size of the pulverized material is reduced to, preferably, about 0.1 to 1.0 μm.

The lithium compound may be added to the raw material mixture before calcination as described above, or may be added during the pulverization step after calcination or during the green sheet fabrication step. When Li₂CO₃ is used as at least one lithium compound source, it is preferable to add it during the green sheet fabrication step because it may be dissolved in water. When glass is used as at least one lithium compound source, it is preferable to add it during the pulverization step after calcination in order to disperse it finely.

### <Fabrication Step of Green Sheet for Forming First Region>

A slurry is fabricated by mixing the composition for forming a first region, an organic binder such as a polyvinyl butyral-based resin or an acrylic-based resin, an organic solvent such as acetone, ethanol, or toluene, a plasticizer, and the like, and then pulverizing the mixture. Then, the obtained slurry is formed into a sheet shape with a predetermined thickness by a doctor blade method or the like, and then punched into a predetermined shape, thereby fabricating a green sheet for forming a first region.

### <Formation Step of Sheet for Forming First Region>

A conductive paste is applied onto a surface of the green sheet by a screen printing method or the like. Thereby, a coil sheet having a coil conductor pattern formed on the green sheet is obtained. In addition, a through hole sheet having a through hole conductor pattern formed on the green sheet is obtained by a similar procedure.

### <Preparation Step of Composition for Forming Second Region>

A composition for forming a second region is obtained by weighing and mixing non-magnetic materials. When a mixed powder of borosilicate glass powder and at least one selected from the group consisting of forsterite powder and willemite powder is used as the non-magnetic material, a glass powder including boron, silicon, barium, and calcium in a predetermined ratio is prepared as the borosilicate glass. In addition, at least one selected from the group consisting of forsterite powder and willemite powder is prepared.

### <Fabrication Step of Green Sheet for Forming Second Region>

A slurry is fabricated by mixing the composition for forming a second region, an organic binder such as a polyvinyl butyral-based resin or an acrylic-based resin, an organic solvent such as acetone, ethanol, or toluene, a plasticizer, and the like, and then pulverizing the mixture. Then, the obtained slurry is formed into a sheet shape with a predetermined thickness by a doctor blade method or the like, and then punched into a predetermined shape, thereby fabricating a green sheet for forming a second region.

### <Formation Step of Sheet for Forming Second Region>

A conductive paste is applied to a surface of the green sheet by a screen printing method or the like. Thereby, a coil sheet on which a coil conductor pattern is formed on the green sheet is obtained. In addition, a through hole sheet on which a through hole conductor pattern is formed on the green sheet is obtained by a similar procedure.

### <Laminate Fabrication Step>

A laminate is fabricated by laminating and thermocompression-bonding the coil sheets and the through hole sheets for forming the first region and the second region.

### <Firing Step>

The laminate is singulated by cutting it into a predetermined size with a dicer or the like. The singulated laminate is fired. The firing temperature may be, for example, 860° C. or higher and 920° C. or lower. The firing time may be, for example, 2 hours or more and 8 hours or less. By firing the laminate, the coil conductor and the through hole conductor are electrically connected. Thereby, a component including a body and a coil is obtained. The component may be subjected to, for example, barrel polishing to round the corners and ridge portions.

In the manufacturing method of a coil component according to the present embodiment, the composition for forming a first region includes at least one lithium compound. Therefore, in the firing step, the lithium compound is stably supplied from the first region to the second region. As a result, the sinterability of the second region is enhanced.

### <External Electrode Formation Step>

First, a conductive paste including silver and glass frit is applied to a pair of end faces of the component. Next, each of the obtained coating films is baked, thereby forming a base electrode layer on the surfaces of the pair of end faces of the component.

Thereafter, a nickel coating and a tin coating are sequentially formed on the surface of each base electrode layer by electrolytic plating or the like. Thereby, a coil component including a body, a pair of external electrodes, and a coil is obtained.

Although the embodiments and modifications of the coil component of the present disclosure and the embodiment of the manufacturing method thereof have been described above, the present disclosure is not necessarily limited to the above-described embodiments and modifications, and various changes can be made without departing from the gist thereof.

### SUMMARY OF THE PRESENT DISCLOSURE

The summary of the present disclosure is as follows.
[1] A coil component, comprising:
a body including a pair of end faces opposing each other; and
a coil disposed within the body,
wherein the coil includes at least one coil conductor,
the body includes a first region and a second region provided at mutually different positions in a direction along a coil axis,
the first region includes a main component and a sub-component,
the main component is composed of 35.0 to 50.0 mol % of iron oxide in terms of Fe₂O₃, 1.0 to 15.0 mol % of copper oxide in terms of CuO, 1.0 to 35.0 mol % of zinc oxide in terms of ZnO, and a remainder of nickel oxide,
the sub-component includes 1.2 parts by mass or less of at least one lithium compound in terms of Li₂O with respect to 100 parts by mass of the main component, and
the second region includes a non-magnetic material.
   [2] The coil component according to [1], wherein a content of the at least one lithium compound in the sub-component is 0.005 to 0.50 parts by mass in terms of Li₂O with respect to 100 parts by mass of the main component.
   [3] The coil component according to [1] or [2], wherein the coil is disposed such that a coil axis thereof is aligned with a direction in which the pair of end faces oppose each other,
the body includes a pair of first body portions each including a corresponding one of the pair of end faces, and a second body portion located between the pair of first body portions,
the second body portion includes the first region and the second region, and
the at least one coil conductor includes a coil conductor disposed in the second body portion.
   [4] The coil component according to any one of [1] to [3], wherein the non-magnetic material includes a glass-based material.
   [5] The coil component according to any one of [1] to [4], wherein the non-magnetic material has a magnetic permeability and a relative permittivity that are respectively smaller than a magnetic permeability and a relative permittivity of the ferrite composition.
   [6] The coil component according to any one of [3] to [5], wherein a central portion among three portions obtained by trisecting the second body portion in a direction along the coil axis includes the second region.
   [7] The coil component according to [6], wherein each of the three portions includes the first region and the second region.
   [8] The coil component according to any one of [3] to [7], wherein the second region includes a plurality of regions provided at respectively different positions in a direction along the coil axis.
   [9] The coil component according to [8], wherein the plurality of regions are provided symmetrically with respect to a central position of a length of the second body portion in a direction along the coil axis.
   [10] The coil component according to [8] or [9], wherein the plurality of regions are provided at substantially equal intervals in a direction along the coil axis.
   [11] The coil component according to [8], wherein the plurality of regions are provided so as to be biased toward one of the pair of first body portions.

### EXAMPLES

Hereinafter, the present disclosure will be described in more detail with reference to Examples, but the present disclosure is not limited to the following Examples.

### [Manufacture of Coil Component]

### Example 1

A coil component illustrated in FIGS. 1 to 3 was obtained through the following steps.

### (Preparation Step of Composition for Forming First Region)

Fe₂O₃, CuO, ZnO, and NiO were weighed as main components.

Each component was weighed so that the content in the first region obtained by firing would be the value shown in Table 1. Li₂CO₃ was added to the main components. The amount of Li₂CO₃ added in terms of Li₂O with respect to 100 parts by mass of the main components is shown in Table 1. Next, these weighed materials were wet-mixed to obtain a raw material mixture. The obtained raw material mixture was dried and then calcined (temperature: 700° C.). The raw material mixture after calcination was pulverized to obtain a powdery composition for forming a first region.

### (Fabrication Step of Green Sheet for Forming First Region)

A slurry was fabricated by mixing and then pulverizing the composition for forming a first region, an organic binder such as an acrylic-based resin, a mixture of acetone and methyl ethyl ketone, and a plasticizer. Then, the obtained slurry was formed into a sheet shape with a predetermined thickness by a doctor blade method, and then punched into a predetermined shape, thereby fabricating a green sheet for forming a first region.

### (Formation Step of Sheet for Forming First Region)

A conductive paste was applied to a surface of the green sheet by a screen printing method. Thereby, a coil sheet having a coil conductor pattern formed on the green sheet was obtained. In addition, a through hole sheet having a through hole conductor pattern formed on the green sheet was obtained by a similar procedure.

### (Preparation Step of Composition for Forming Second Region)

MgO, ZnO, CuO, and SiO₂ were prepared as a forsterite material and a willemite material. These components were weighed so as to form a composition having the formula 2.0 (0.66MgO·0.26ZnO·0.08CuO)·SiO₂ after firing. In addition, a B₂O₃—SiO₂—BaO—CaO-based glass was prepared. The weighed materials of the forsterite material and the willemite material were wet-mixed for 24 hours using a ball mill to obtain a mixture. The mixture was dried in a dryer, and further calcined at 1000° C. in a batch furnace to obtain a calcined powder. The B₂O₃—SiO₂—BaO—CaO-based glass was added to this calcined powder, and the resulting mixture was wet-mixed for 16 hours using a ball mill. The obtained mixture was dried in a dryer to obtain a composition for forming a second region.

### (Fabrication Step of Green Sheet for Forming Second Region)

A slurry was fabricated by mixing and then pulverizing the composition for forming a second region, an organic binder such as an acrylic-based resin, a mixture of acetone and methyl ethyl ketone, and a plasticizer. Then, the obtained slurry was formed into a sheet shape with a predetermined thickness by a doctor blade method, and then punched into a predetermined shape, thereby fabricating a green sheet for forming a second region.

### (Formation Step of Sheet for Forming Second Region)

A conductive paste was applied to a surface of the green sheet by a screen printing method. Thereby, a coil sheet having a coil conductor pattern formed on the green sheet was obtained. In addition, a through hole sheet having a through hole conductor pattern formed on the green sheet was obtained by a similar procedure.

### (Laminate Fabrication Step)

A laminate was fabricated by laminating and thermocompression-bonding the coil sheets and the through hole sheets for forming the first region and the second region.

### (Firing Step)

The laminate was singulated by cutting it into a predetermined size with a dicer. The singulated laminate was fired (firing temperature: 900° C., firing time: 2 hours) to obtain a component including a body and a coil.

### (External Electrode Formation Step)

A conductive paste (material: silver and glass frit) was applied to a pair of end faces of the component. Next, each of the obtained coating films was baked, thereby forming a base electrode layer on the surfaces of the pair of end faces of the component.

Thereafter, a nickel coating and a tin coating were sequentially formed on the surface of each base electrode layer by electrolytic plating. Thereby, a coil component including a body, a pair of external electrodes, and a coil was obtained. The body includes a first region including a ferrite composition and a second region including a non-magnetic material. The configuration of the coil component is shown below.

### (Configuration of Coil Component)

Number of first regions 5a: Four
Number of second regions 5b: Four
Thickness of each of the first regions 5a: 71 μm, 71 μm, 71 μm, and 27 μm in order from the first region 5a located on the side of one of the pair of end faces
Total value T1 of thicknesses of the four first regions 5a: 240 μm
Thickness of each of the second regions 5b: 18 μm
Total value T2 of thicknesses of the four second regions 5b: 72 μm
Ratio (T2/T1): 0.3

### Examples 2 to 4, Comparative Example 2

Coil components were obtained in the same manner as in Example 1, except that the amount of Li₂CO₃ added in terms of Li₂O with respect to 100 parts by mass of the main components was changed to the values shown in Table 1.

### Comparative Example 1

A coil component was obtained in the same manner as in Example 1, except that Li₂CO₃ was not blended in the raw material mixture.

### [Thermal Shock Test]

### Examples 1 to 4, Comparative Examples 1, 2

The coil components of each Example and Comparative Example were subjected to 2000 cycles of a predetermined temperature profile in a range of −55 to +125° C. The inductance L of the coil component at the initial stage and after the test was measured at a measurement frequency of 10 MHz, and the inductance change rate before and after the test was determined. For each Example and Comparative Example, the inductance change rate was determined for 40 coil components, and the average value was determined. The results are shown in Table 1.

### [Measurement of Magnetic Permeability and Relative Permittivity of Ferrite Composition]

To 100 parts by mass of the powdery composition for forming a first region, 10.0 parts by mass of a 6% by mass polyvinyl alcohol aqueous solution was added as a binder and granulated to obtain granules. These granules were pressure-molded to obtain a molded body of a toroidal shape (dimensions=outer diameter 13 mm× inner diameter 6 mm× height 3 mm) and a molded body of a disk shape (dimensions=outer diameter 12 mm× height 2 mm). Each of these molded bodies was fired in air at 900° C. for 2 hours to obtain a toroidal core sample and a disk sample as sintered bodies. Furthermore, the following characteristic evaluations were performed on each of the obtained samples. The magnetic permeability of the ferrite composition was measured for the toroidal core sample using an RF Impedance/Material Analyzer (E4991A manufactured by Agilent Technologies, Inc.) and a test fixture (16454A manufactured by Agilent Technologies, Inc.). The measurement conditions were a measurement frequency of 1 MHz and a measurement temperature of 25° C. Regarding the relative permittivity of the ferrite composition, In—Ga electrodes were applied to both surfaces of the disk sample, and the capacitance C was measured using an LCR meter (4285A manufactured by HEWLETT PACKARD) under the conditions of a measurement temperature of 25° C., a frequency of 1 MHz, and a measurement signal level of 1 Vrms. The relative permittivity was calculated from the obtained capacitance C, the electrode area of the sintered body, and the distance between the electrodes. The results are shown in Table 1.

### [Measurement of Magnetic Permeability and Relative Permittivity of Non-Magnetic Material]

To 100 parts by mass of the powdery composition for forming a second region, 10.0 parts by mass of a 6% by mass aqueous solution of polyvinyl alcohol was added as a binder and granulated to obtain granules. These granules were pressure-molded to obtain a molded body of a toroidal shape (dimensions=outer diameter 13 mm× inner diameter 6 mm× height 3 mm) and a molded body of a disk shape (dimensions=outer diameter 12 mm× height 2 mm). Each of these molded bodies was fired in air at 900° C. for 2 hours to obtain a toroidal core sample and a disk sample as sintered bodies. Furthermore, the following characteristic evaluations were performed on each of the obtained samples. The magnetic permeability of the non-magnetic material was measured for the toroidal core sample using an RF Impedance/Material Analyzer (E4991A manufactured by Agilent Technologies, Inc.) and a test fixture (16454A manufactured by Agilent Technologies, Inc.). The measurement conditions were a measurement frequency of 1 MHz and a measurement temperature of 25° C. Regarding the relative permittivity of the non-magnetic material, In—Ga electrodes were applied to both surfaces of the disk sample, and the capacitance C was measured using an LCR meter (4285A manufactured by HEWLETT PACKARD) under the conditions of a measurement temperature of 25° C., a frequency of 1 MHz, and a measurement signal level of 1 Vrms. The relative permittivity was calculated from the obtained capacitance C, the electrode area of the sintered body, and the distance between the electrodes. The magnetic permeability of the non-magnetic material was 1. The relative permittivity of the non-magnetic material was 7.

TABLE 1

| | First region | | | | | | | Change |
|---|---|---|---|---|---|---|---|---|
| | | | | | Li₂O | Magnetic | Relative | rate of L |
| | Fe₂O₃ | NiO | ZnO | CuO | parts by | permeability | permittivity | value |
| | mol % | mol % | mol % | mol % | mass | — | — | % |
| Comparative | 48.5 | 23.5 | 18 | 10 | 0 | 188 | 15 | 11.2 |
| Example 1 | | | | | | | | |
| Example 1 | 48.5 | 23.5 | 18 | 10 | 0.01 | 183 | 15 | 4.9 |
| Example 2 | 48.5 | 23.5 | 18 | 10 | 0.045 | 167 | 15 | 4.3 |
| Example 3 | 48.5 | 23.5 | 18 | 10 | 0.5 | 90 | 14 | 5.5 |
| Example 4 | 48.5 | 23.5 | 18 | 10 | 1.0 | 45 | 13 | 8.1 |
| Comparative | 48.5 | 23.5 | 18 | 10 | 1.5 | 31 | 13 | 14.5 |
| Example 2 | | | | | | | | |

### REFERENCE SIGNS LIST

1: body, la: end face, 1c: side face, 3a: body portion, 3b: body portion, 3c: body portion, 5a: first region, 5b: second region, 7a: portion, 7b: portion, 7c: portion, 10: external electrode, 10c: electrode portion, 10e: edge, 30: coil, 31: coil conductor, CL1: central position, ED1: coil component, D1: first direction.

What is claimed is:

1. A coil component, comprising:
a body including a pair of end faces opposing each other; and
a coil disposed within the body,
wherein the coil includes at least one coil conductor,
the body includes a first region and a second region provided at mutually different positions in a direction along a coil axis,
the first region includes a ferrite composition composed of a main component and a sub-component,
the main component is composed of 35.0 to 50.0 mol % of iron oxide in terms of Fe₂O₃, 1.0 to 15.0 mol % of copper oxide in terms of CuO, 1.0 to 35.0 mol % of zinc oxide in terms of ZnO, and a remainder of nickel oxide,
the sub-component includes 1.2 parts by mass or less of at least one lithium compound in terms of Li₂O with respect to 100 parts by mass of the main component, and
the second region includes a non-magnetic material.

2. The coil component according to claim 1, wherein a content of the at least one lithium compound in the sub-component is 0.005 to 0.50 parts by mass in terms of Li₂O with respect to 100 parts by mass of the main component.

3. The coil component according to claim 1, wherein the non-magnetic material includes a glass-based material.

4. The coil component according to claim 1, wherein the non-magnetic material has a magnetic permeability and a relative permittivity that are respectively smaller than a magnetic permeability and a relative permittivity of the ferrite composition.

5. The coil component according to claim 1,
wherein the coil is disposed such that a coil axis thereof is aligned with a direction in which the pair of end faces oppose each other,
the body includes a pair of first body portions each including a corresponding one of the pair of end faces, and a second body portion located between the pair of first body portions,
the second body portion includes the first region and the second region, and
the at least one coil conductor includes a coil conductor disposed in the second body portion.

6. The coil component according to claim 5, wherein a central portion among three portions obtained by trisecting the second body portion in a direction along the coil axis includes the second region.

7. The coil component according to claim 6, wherein each of the three portions includes the first region and the second region.

8. The coil component according to claim 5, wherein the second region includes a plurality of regions provided at respectively different positions in a direction along the coil axis.

9. The coil component according to claim 8, wherein the plurality of regions are provided symmetrically with respect to a central position of a length of the second body portion in a direction along the coil axis.

10. The coil component according to claim 8, wherein the plurality of regions are provided at substantially equal intervals in a direction along the coil axis.

11. The coil component according to claim 8, wherein the plurality of regions are provided so as to be biased toward one of the pair of first body portions.
